(19) United States
(12) Patent Application Publication
(10) Pub. No.: US 2008/0065751 A1
(43) Pub. Date: Mar. 13, 2008

(54) METHOD AND COMPUTER PROGRAM PRODUCT FOR ASSIGNING AD-HOC GROUPS

(75) Inventor: Kenneth B. Hampson, Westford, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/530,173

(22) Filed: Sep. 8, 2006

(51) Int. Cl. G06F 15/173

(52) U.S. Cl. 709/223

(57) ABSTRACT

A computer program product provides an ad-hoc group to an application, through instructions for: retrieving at least one group comprising listings of individuals; using at least one operand, at least one of selecting and de-selecting individuals from the at least one group to provide the ad-hoc group.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to designating groups and particularly to use of set theory to refine selection of the groups.

2. Description of the Related Art

In many instances, selection of groups is an inaccurate or tedious process. Consider use of an email client. In the case where an email client makes use of groups, one may wish to email an entire group. However, if an individual wishes to send email to selected individuals from various groups, the options are limited. One solution calls for selecting the various groups and sending the email to an excessively broad audience. This can be annoying both to the recipients as well as the sender.

Another solution is to specify the recipients (who are members of various groups) by hand. Manual specification involves looking up the members and filtering the list as appropriate. Basically, this approach requires the manual resolution of group members, manual member filtration, and manual member entry, which is both time-consuming and tedious.

What are needed are techniques for simplifying the selection of groups. Preferably, the techniques provide for minimal user input and therefore rapid task completion.

### SUMMARY OF THE INVENTION

The shortcomings of the prior art are overcome and additional advantages are provided through the provision of a computer program product stored on machine readable media for executing machine readable instructions to provide an ad-hoc group to an application, the instructions for: retrieving at least one group including listings of individuals; using at least one operand, at least one of selecting and de-selecting individuals from the at least one group to provide the ad-hoc group.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a computer program product stored on machine readable media for executing machine readable instructions is provided and produces an ad-hoc group for one of an email client, an access control application and a messaging application, the instructions for: providing a selection facility, a query facility, an operand selection facility and a graphic depiction facility; retrieving at least one group including listings of individuals; using at least one operand including at least one of a plus, a minus, a less than, a greater than, a NOT, an OR and an AND, at least one of selecting and de-selecting individuals from the at least one group to provide the ad-hoc group and updating the ad-hoc group upon at least one of transmission, saving, after a predetermined period of time and live-time; wherein the ad-hoc group includes at least one of a complement of two or more groups, an intersection of two or more groups and a union of two or more groups.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts aspects of a computing infrastructure for implementation of the teachings herein;

FIG. 2 illustrates an exemplary user interface and steps for selecting an ad-hoc group; and

FIG. 3 illustrates another exemplary user interface for selecting the ad-hoc group.

The detailed description explains the preferred embodiments of the invention, together with advantages and features, by way of example with reference to the drawings.

### DETAILED DESCRIPTION OF THE INVENTION

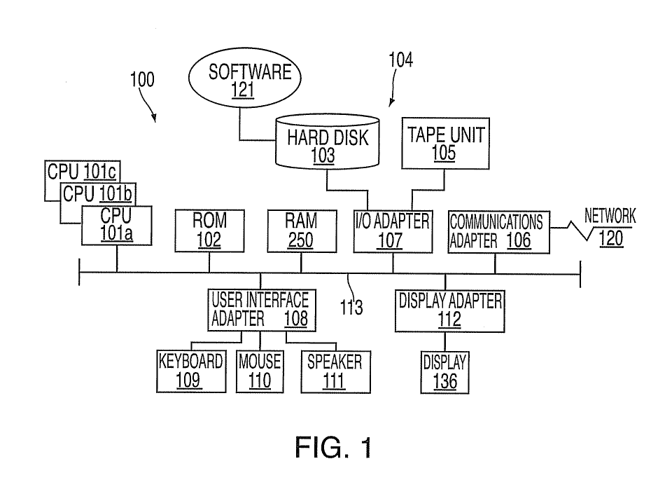

Referring now to FIG. 1, an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 104) for providing for ad-hoc groups. As disclosed herein, the instructions are referred to as ad-hoc grouping software 121. The software 121 may be produced using software development tools as are known in the art.

Thus, as configured FIG. 1, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

As is known in the art, the system 100 may perform various functions. For example, the system 100 may provide server capabilities, or provide client resources. The system 100 may operate in a mixed platform environment. For example, the system 100, and other similar resources may operate any one of Windows, AIX and Solaris operating systems. The teachings herein provide for software 121 that is typically flexible. That is, the software 121 will typically operate in cross platform environments as well as with multiple systems.

As examples of the flexibility, the software 121 may reside on either the server or client-side of the system. In one example, the software 121 resides in the server side, and is “called into” by client code, which would then process the results for display, etc.

The concept of Ad Hoc Groups allows for the quick and temporary specification of a group based upon existing, traditional groups without needing to specify individual members of that group, as is sometimes needed when sending email to (or potentially creating access control lists (ACL) entries) for a subset of a group of people. The ad-hoc grouping software 121 makes use of general set theory.

The ad-hoc grouping software 121 addresses the prior art technique for customizing a list by specifying the members by hand. The prior art technique calling for looking up members and filtering each list as appropriate. More specifically, this has called for manual resolution of group members, manual member filtration, and manual member entry, all of which are time-consuming and tedious. The ad-hoc grouping software 121 provides a solution by automating aspects of the prior art processes and requiring much less input from an end user.

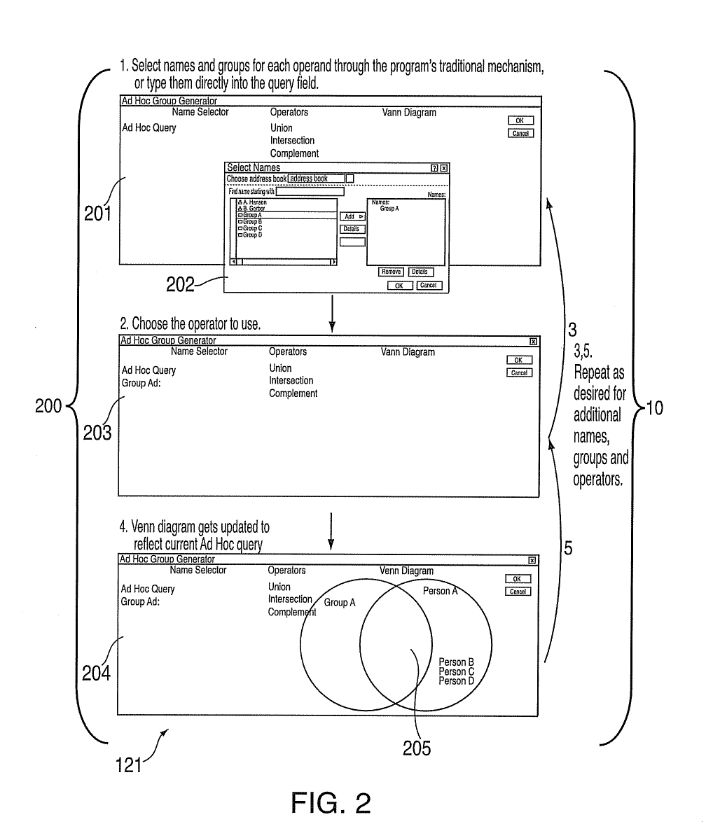

Referring now to FIG. 2, aspects of the ad-hoc grouping software 121 are shown. The aspects include components of the user interface 200, as well as steps for a method to establish an ad-hoc group.

In one embodiment, depicted in FIG. 2, the user interface 200 provides a selection facility 201. The selection screen 201 provides a query facility 202 as a pop-up menu. As one skilled in the art will understand, a variety of inputs and interfaces may be used. The user makes use of the query facility 202 to provide for selection and de-selection of members and individuals. In the embodiment depicted in FIG. 2, an operand selection facility 203 is provided to facilitate aspects of the selection and de-selection of the members and individuals. In this embodiment, the user is also provided with a graphic depiction facility 204 of the ad-hoc group 205 created by at least one of selection and de-selection. Typically, the ad-hoc grouping software 121 provides the user with an opportunity to save (i.e., store) the ad-hoc group 205 as desired. Once the ad-hoc group 205 has been established, the user is permitted to use the ad-hoc group 205 for emailing, future reference, or for other purposes as desired.

Also as shown in FIG. 2, the ad-hoc grouping software 121 provides a method 10 for creating the ad-hoc groups 205. In this embodiment, the method 10 calls for selecting names and groups 1, choosing operators 2, and updating the ad-hoc group 4. Aspects of the method 10 may be repeated 3, 5 as desired.

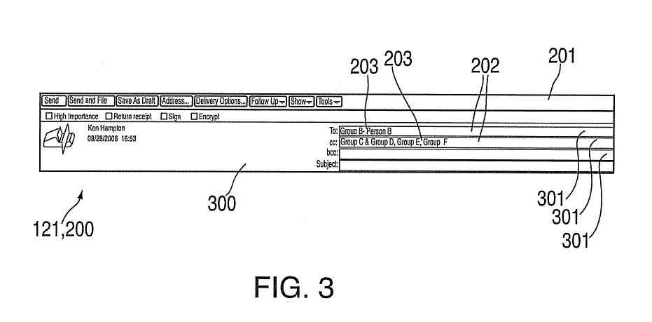

Another embodiment of the user interface 200 for the ad-hoc grouping software 121 is depicted in FIG. 3. In FIG. 3, a typical addressing section of an email client 300 is used to provide users with ad-hoc grouping capabilities. Address lines 301 of the email client 300 provide users with access to the query facility 202 and the operand selection facility 203. In this embodiment, referred to as a “command line” embodiment, the query facility 202 and the operator selection facility 203 are accessed by use of operands available at the keyboard 109 or elsewhere in the email client 300 (such as through a menu). Updating the ad-hoc group 4 may occur upon transmission, saving, after a predetermined period of time, live-time (such as when operators are added), or in any manner deemed suitable.

Exemplary operands include mathematical operands such plus (+), minus (−), less than (<), greater than (>) as well as logical operands such as NOT, OR and AND. Other operands may be used as deemed suitable.

Various applications that would make use of ad-hoc grouping software 121 include applications that provide for email addressing, Access Control Lists, messaging applications (such as SMS). The groups could range from simple to complicated in theory, following the rules of set theory to apply the specified set operations.

One could create the ad-hoc group 205 that is a result of various operations. For example, the ad-hoc group 205 could be a result of at least one of a complement of two or more groups, an intersection of two or more groups and a union of two or more groups.

Depending on the situation, one could use either of the foregoing three types of ad-hoc groups 205. To filter out one or more subsets from a group, one would use the complement type. To use the overlap between two or more groups, one would use the intersection type. To specify multiple groups, one would use the union type (note that the union is similar in practice to listing multiple, independent groups. However, the teachings herein provide for, among other things, automatically filtering duplicates, as an advantage over the prior art).

As one exemplary use of the ad-hoc grouping software 121, consider that one might want to have a surprise birthday get-together for a colleague within a respective workgroup. With traditional email addressing methods, one would need to explicitly specify the email address for each member of the workgroup except for the colleague to be surprised. Using the ad-hoc grouping software 121, this task would be simplified. That is, the software 121 would provide for sending an email to everyone in the workgroup except for the one individual. This would use a complement of two groups, where group A is the name of the workgroup, and group B is a group having the individual in question. An exemplary syntax would look something like: (A-B).

As another example, consider that one might want to invite a group of people to a meeting. The desired group includes only those people who both work on a specific platform and on a specific product. Unfortunately, the existing groups only provide groups that include all people who work on the respective platform and all people who work on the respective product. That is, there are a number of people in each group that do not work on both the platform and the product.

Using the ad-hoc grouping software 121, one could address an invitation to the intersection of those two groups to send the invitation to the correct, more targeted, audience. In a prior art scenario, the invitation would most likely be sent to everyone in both groups, resulting in a large subset of people who do not need to attend the meeting still receiving the invitation.

Considering an embodiment involving an Access Control List (ACL), a similar notion applies. To specify that everyone from a group except a certain subset of people should have a certain access level, one could use a complement type ad-hoc group 205.

This complement type of ad-hoc group 205 could be implemented in a series of steps. Exemplary steps are provided in Table 1.

TABLE 1
Exemplary Steps for Generation of an ACL

| Step | Action |
|---|---|
| 1 | Develop a simple notation through which the end user can |
| | represent Ad Hoc Groups. For example: |
| 2 | (A − B) to get the subset of members in A but not B |
| 3 | (A \| B) to get the subset of members in both A and B (intersection) |
| 4 | (A + B) to get all of the members in A and all of the members in |
| | B (union) |
| 5 | Interpret Ad Hoc Groups notation, treating each group as an |
| | independent set |
| 6 | Fully resolve the membership of each set (including nested groups) |
| 7 | Then apply the specified set theory operation (as interpreted in |
| | step 2) as appropriate using these resolved sets |
| 8 | Skim off the appropriate members in the case of a complement |
| | type group |
| 9 | Find the overlapping members in the case of an intersection |
| | type group |
| 10 | Add the members together in the case of a union type group |
| 11 | Return the resulting set of members to be used for either email |
| | addressing or the ACL entry. |

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media for executing machine readable instructions to provide an ad-hoc group to an application, the instructions for:
retrieving at least one group comprising listings of individuals; and
using at least one operand, at least one of selecting and de-selecting individuals from the at least one group to provide the ad-hoc group.

2. The computer program product as in claim 1, wherein the application comprises one of an email client, an access control application and a messaging application.

3. The computer program product as in claim 1, wherein the operand comprises at least one of a plus, a minus, a less than, a greater than, a NOT, an OR and an AND.

4. The computer program product as in claim 1, wherein the ad-hoc group comprises at least one of a complement of two or more groups, an intersection of two or more groups and a union of two or more groups.

5. The computer program product as in claim 1, further comprising instructions for providing a selection facility.

6. The computer program product as in claim 1, further comprising instructions for providing a query facility.

7. The computer program product as in claim 1, further comprising instructions for providing an operand selection facility.

8. The computer program product as in claim 1, further comprising instructions for providing a graphic depiction facility.

9. The computer program product as in claim 1, further comprising instructions for receiving input from a user via a command line.

10. The computer program product as in claim 9, wherein the ad-hoc group is updated upon at least one of transmission, saving, after a predetermined period of time and live-time.

11. A computer program product stored on machine readable media for executing machine readable instructions to provide an ad-hoc group to one of an email client, an access control application and a messaging application, the instructions comprising instructions for:
providing a selection facility, a query facility, an operand selection facility and a graphic depiction facility;
retrieving at least one group comprising listings of individuals;
using at least one operand comprising at least one of a plus, a minus, a less than, a greater than, a NOT, an OR and an AND, at least one of selecting and de-selecting individuals from the at least one group to provide the ad-hoc group and updating the ad-hoc group upon at least one of transmission, saving, after a predetermined period of time and live-time;
wherein the ad-hoc group comprises at least one of a complement of two or more groups, an intersection of two or more groups and a union of two or more groups.
